(19) United States
(12) Patent Application Publication
(10) Pub. No.: US 2003/0193705 A1
(43) Pub. Date: Oct. 16, 2003

(54) Photonic constant envelope RF modulator

(76) Inventors: William W. Anderson, Half Moon Bay, CA (US); Denis Rampton, Union City, CA (US)

Correspondence Address: TOWNSEND AND TOWNSEND AND CREW, LLP, TWO EMBARCADERO CENTER, EIGHTH FLOOR, SAN FRANCISCO, CA, 94111-3834, US

(21) Appl. No.: 09/986,320

(22) Filed: Nov. 8, 2001

(51) Int. Cl. G02F 1/00; G02B 26/00

(52) U.S. Cl. 359/237

(57) ABSTRACT

A system for performing photonic constant envelope modulation utilizing a frequency shifted optical signal and a pure phase modulated optical signal. A coupler superposes the pure phase modulated signal and the frequency shifted optical signal. A set of detectors generates a photocurrent signal based on the superposed signals. A splitter generates a first optical signal and a second optical signal, wherein each represents nominally one half of an input optical signal. A filter, coupled to the set of detectors, is operable to remove a DC current from the photocurrent signal.

### BACKGROUND OF THE INVENTION

1. Field of the Invention

This present invention relates to methods and system for digital modulation. More specifically, the present invention relates to methods and systems to generate continuous phase, constant envelope modulation of an Intermediate Frequency (IF) or Radio Frequency (RF) carrier.

2. Description of the Prior Art

Modulation methods and systems, such as Nyquist Spectral Filtering, M-ary Phase Shift Keying (PSK) and M-ary Quadrature Amplitude Modulation (QAM), are employed to obtain bandwidth efficient RF digital links. These traditional modulation methods and systems are implemented in both single RF channel applications and frequency division multiple access (FDMA) applications. Filtering and/or amplitude modulation are required to reduce adjacent channel interference generated by spectral sidelobes associated with each of the aforementioned techniques. This filtering and/or amplitude modulation produces amplitude variations in the RF envelope. Amplitude variations in the RF envelope make the waveform vulnerable to performance degradation as a result of non-linearity in the communication channel. M-ary PSK and QAM obtain increased bandwidth efficiency by increasing the number of phase states. As the number of phase states is increased, the bandwidth efficiency increases. An increase in phase states, however, degrades link power efficiency of the RF link.

Standard Continuous Phase Modulation (CPM) is also employed to obtain bandwidth efficient RF digital links. CPM is typically implemented in frequency division multiple access (FDMA) applications. At present, CPM is limited to low capacity systems and/or low data rate applications as a result of sampling rate requirements and the complexity associated with performing the digital processing.

Therefore, there is a need for a modulation method and system that obtains high capacity bandwidth efficient RF digital links in single RF channel and frequency division multiple access applications. There is also a need for the modulation method and system to have spectral and power efficiency. There is also a need for the modulation method and system to obtain the high capacity bandwidth efficient RF digital links in a less complex manner.

### SUMMARY OF THE INVENTION

Based on the above and foregoing, it can be appreciated that there presently exists a need in the art for a modulation method and system which overcomes the above-described deficiencies. The present invention was motivated by a desire to overcome the drawbacks and shortcomings of present modulation methods and systems and thereby fulfill this need in the art.

According to embodiments of the present invention, a method and a system utilizing photonic Continuous Phase Modulation (CPM) of an optical signal to perform constant envelope digital modulation of an IF or RF carrier signal are provided. This is achieved by constructing a lightwave circuit which will generate a photocurrent in accordance with the mathematical function: i_{RF}(t)=I_{RF} sin (ω_{RF}t+θ(t)+Θ₀), where ω_{RF} is the carrier frequency in radians per second, θ(t) is the information data stream modulated onto the carrier signal and Θ₀ is an arbitrary fixed phase determined by choice of time zero. The CPM described by the mathematical function provides simultaneous power and bandwidth efficiency. The lightwave circuit also greatly simplifies the implementation complexity of CPM modulators, while providing a major increase in the upper data rate limit or throughput capacity.

Simplification occurs since all of the waveform generation steps are carried out in the analog domain utilizing small phase and frequency perturbations on optical frequency signals. The phase modulation and frequency shift operations are carried out within single electro-optic and acousto-optic devices. This approach stands in contrast to the conventional all electronic synthesis of the CPM waveform wherein the CPM modulated waveform is synthesized from multiple bits per cycle. The upper data rate limitation is determined by the response of electro-optic phase modulators, currently available in the 10 Gbit/second range and laboratory demonstrated performance to 40 Gbit/second. We note that by interleaving four 10 Gbit/second data streams in four 10 Gbit/second modulators serially connected, a 40 Gbit/second modulated optical signal can be obtained.

A method of performing photonic constant envelope modulation includes generating a frequency shifted optical signal and a pure phase modulated optical signal. By superposing and detecting these two optical signals, a pure phase modulated RF or IF photocurrent signal is generated. The pure phase modulated photocurrent signal corresponds to a digital information data stream. DC current may be removed from the photocurrent. The CPM allows modulation in high data rate applications by increasing the upper limit on data rates and throughput capacity.

In an embodiment of the present invention, a first optical signal and a second optical signal are generated. Each optical signal is derived from an original optical signal applied to an input and divided into nominally equal halves of an input optical signal.

In an embodiment of the present invention, the frequency shifted optical signal is generated in an acousto-optic device. Generating the frequency shifted optical signal includes diffracting the first optical signal with an acoustic wave of a carrier signal at frequency ω_{RF}.

In an embodiment of the present invention, the pure phase modulated optical signal is generated in an electro-optic phase modulator. Generating the pure phase modulated optical signal includes passing the second optical signal through an electro-optically active material subject to an electric field containing the information data stream.

In an embodiment of the present invention, two optical signals are superposed. The two superposed optical signals include the phase modulated optical signal superposed on the frequency shifted optical signal.

A system for performing photonic constant envelope modulation includes a first modulator operable to generate a frequency shifted optical signal. The system further includes a second modulator operable to generate a nominally pure phase modulated optical signal and a set of detectors operable to generate a pure phase modulated photocurrent signal corresponding to an information data stream.

### BRIEF DESCRIPTION OF THE DRAWINGS

The details of the present invention, both as to its structure and operation can best be understood by referring to the following description with reference to the accompanying drawings in which:

FIG. 1 depicts an exemplary block diagram of a lightwave circuit according to an embodiment of the present invention; and

FIG. 2 depicts an exemplary flow diagram of a method for performing photonic constant envelope RF modulation according to an embodiment of the present invention.

### DETAILED DESCRIPTION OF THE INVENTION

The present invention is now described more fully hereinafter with reference to the accompanying drawings that show a preferred embodiment of the present invention. The present invention, however, may be embodied in many different forms and should not be construed as limited to embodiments set forth herein. Appropriately, embodiments are provided so that this disclosure will be thorough, complete and fully convey the scope of the present invention.

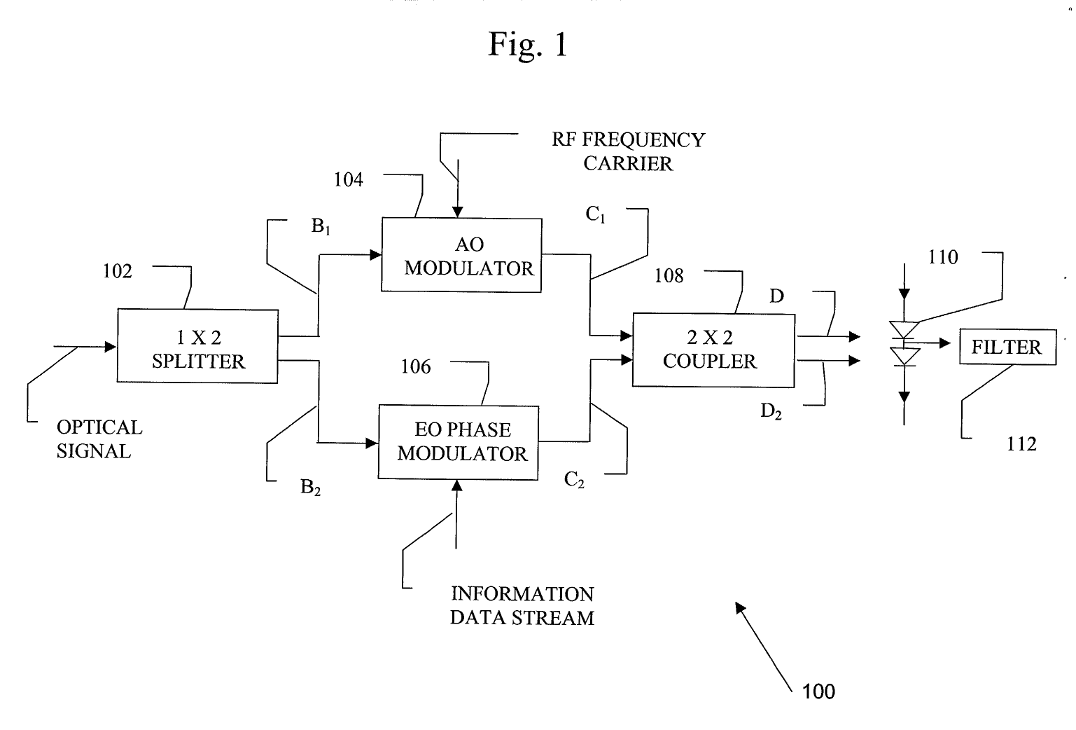

According to embodiments of the present invention, a method and a system for performing photonic constant envelope digital modulation (CPM) of an IF or RF carrier signal are provided. This is achieved by constructing a lightwave circuit which will generate a photocurrent in accordance with the mathematical function: i_{RF}(t)=I_{RF} sin (ω_{RF}t+θ(t)+Θ₀), where ω_{RF} is the carrier frequency in radians per second, θ(t) is the information data stream modulated onto the carrier signal and Θ₀ is an arbitrary fixed phase determined by choice of time zero. An exemplary block diagram of a lightwave circuit according to an embodiment of the present invention is shown in FIG. 1. In the FIG. 1 embodiment, lightwave circuit 100 includes splitter 102, acousto-optic frequency shifter (AO modulator) 104, Electro-optic phase modulator (EO modulator) 106, coupler 108 and detector 110. In another embodiment, lightwave circuit 110 may also include filter 112.

The splitter 102 receives a coherent optical signal as an input to the lightwave circuit 100. In the embodiment of FIG. 1, splitter 102 may be, for example, an adiabatic 1×2 power splitter, a 1×2 directional coupler or a 1×2 multimode interference device (MMI). The coherent optical signal is characterized by optical power, Pₒₚₜ and optical frequency, ωₒₚₜ. The instantaneous amplitude of the optical signal is characterized by the function a=\sqrt{Pₒₚₜ/2}exp(jωₒₚₜt)+c.c, where c.c. in this and following equations is the complex conjugate of the first term and ωₒₚₜ is the optical frequency of the optical signal. Splitter 102 generates two optical signals that are each nominally half of the optical signal received as input. Each half of the optical signal power is provided to an output of splitter 102.

AO modulator 104 is coupled to a first output of splitter 102 to receive one half of the optical signal power as input. In the embodiment of FIG. 1, AO modulator 104 is an acousto-optic frequency shifter. The optical signal received by AO modulator 104 is characterized by the function B₁=\sqrt{Pₒₚₜ/4}exp[j(ωₒₚₜt+θ_{A})]+c.c.. AO modulator 104 also receives as an input an unmodulated RF or IF carrier signal defined by cos(ω_{RF}t). AO modulator 104 generates a frequency shifted optical signal at frequency ωₒₚₜ+ω_{RF} or ωₒₚₜ−ω_{RF}. Generation of the frequency shifted optical signal is implemented by diffracting the optical signal received as an input at a first input of AO modulator 104 by the propagating acoustic wave generated by the RF or IF carrier signal received as an input at a second input of AO modulator 104. Upon application of the carrier signal to the optical signal, shifting of the frequency of the optical signal, either up or down, may be performed by choosing a parallel or an anti-parallel propagating direction for the input optical signal and the input carrier signal. Energy is transferred to or from the incident first optical signal by the acoustic wave. If energy is transferred to the first optical signal from the acoustic wave, the first optical signal frequency is increased by the acoustic wave frequency. If energy is transferred from the first optical signal to the acoustic wave, the first optical signal frequency is decreased by the acoustic wave frequency. The direction of energy transfer is determined by the relative propagation directions of the three signals; (1) the incident first optical signal, (2) the diffracted first optical signal and (3) the acoustic wave. Generally, the amplitude of the carrier signal and the efficiency of AO modulator 104 determine the efficiency of the frequency shifting for the optical signal. For purposes of illustration in this document, we will assume the optical frequency, ωₒₚₜ, is increased by the acoustic wave frequency ω_{RF}. When ωₒₚₜ is increased, the optical signal output of the AO modulator 104 is characterized by C₁=A\sqrt{Pₒₚₜ/4}exp[j((ωₒₚₜ+ω_{RF})t+θ′_{A})]+c.c.. The amplitude factor, A, has a value less than one and represents the diffraction efficiency of the AO modulator 104. The efficiency of the optical frequency shifting or conversion is determined by the amplitude of the carrier signal and the efficiency of AO modulator 104.

EO modulator 106 is coupled to a second output of splitter 102 to receive one half of the optical signal power as an input. In the embodiment of FIG. 1, modulator 106 is an EO phase modulator. The optical signal received by EO modulator 106 is characterized by the function B₂=\sqrt{Pₒₚₜ/4}exp[j(ωₒₚₜt+θ_{B})]+c.c.. Modulator 106 also receives as input an information data stream defined by voltage amplitude v(t), which produces a phase modulation on the optical signal θ(t)=πv(t)/V_{π}. V₉₀ is the sensitivity parameter of EO modulator 106. Any depth of phase modulation, i.e. modulation index, may be obtained by voltage amplification to give the desired magnitude of v(t). EO modulator 106 generates a phase modulated optical signal for output by applying a modulating electrical field to an electro-optically active medium through which the second optical signal is propagating. EO modulator 106 implements the linear electro-optic effect, also known as the “Pockels effect,” to produce pure phase modulation on the received optical signal. The modulating electrical field causes a corresponding modulation of the refractive index of the electro-optically active medium which, in turn, results in a modulation of the phase of the second optical signal propagating in the medium

A first input of coupler 108 is coupled to the output of modulator 106 and a second input of coupler 108 is coupled to the output of modulator 104. In the embodiment of FIG. 1, Coupler 108 may be, for example, a 2×2 directional coupler or a 2×2 multimode interference device. Coupler 108 may also be an adiabatic 2×1 power combiner but with a 6 dB power penalty in the detected photocurrent power. Coupler 108 receives the phase modulated optical signal and the frequency shifted optical signal as inputs. The frequency shifted optical signal received by coupler 108 is characterized by the function C₁=A\sqrt{Pₒₚₜ/4}exp[j((ωₒₚₜ+ω_{RF})t+θ′_{A})]+c.c.. Amplitude factor A in the function characterizing the frequency shifted optical signal accounts for inefficiencies during the optical frequency shifting due to the amplitude of the driving RF carrier signal input to modulator 104. The phase modulated optical signal received by coupler 108 is characterized by C₂=\sqrt{Pₒₚₜ/4}exp[j(ωₒₚₜt+θ(t)+θ′_{B})]+c.c..

Coupler 108 superposes the phase modulated optical signal and the frequency shifted optical signal. Coupler 108 outputs two superposed optical signals, each of which are a superposition of the phased modulated optical signal and frequency shifted optical signal. The two superposed optical signals exhibit a temporal interference pattern between the frequency shifted optical signal and the phase modulated optical signal. The instantaneous amplitude of the superposed optical signal output from, for example, the upper output of the coupler 108 is

D₁=\sqrt{Pₒₚₜ/8}{A exp[j((ωₒₚₜ+ω_{RF})t+θ′_{A})]−jexp[j(ωₒₚₜt+θ(t)+θ′_{B})]}+c.c.. The instantaneous amplitude of the superposed optical signal output from, for example, the lower output of the coupler 108 is

D₂=\sqrt{Pₒₚₜ/8}{−jA exp[j((ωₒₚₜ+ω_{RF})t+θ′_{A})]+exp[j(ωₒₚₜt+θ(t)+θ′_{B})]}+c.c.. In an embodiment of the present invention, one superposed signal and the other superposed signal may be phase shifted from one another by π/2. For example, a 2×2 directional coupler and 2×2 MMI device will shift the superposed signals by π/2.

Detectors 110 are coupled to outputs of Coupler 108 and receive the superposed optical signals from the upper and lower outputs of Coupler 108 as inputs. Detectors 110 may be any suitable photodetector, such as a balanced pair of photodiodes or metal semiconductor metal devices. In the embodiment of FIG. 1, the detectors 110 include an upper detector and a lower detector connected in series. The series connection of the detectors provides a balanced detector configuration wherein the current common to the two detectors flows through the series connected detectors and the current difference between the two detectors flows to the output circuit of the detectors. The detector produces, as outputs, photocurrents that are proportional to the optical powers incident on the detectors. The optical power in the upper output of Coupler 108 corresponding to the optical signal amplitude D₁ is P₁=Pₒₚₜ{(A²+1)/2−A sin (ω_{RF}t−θ(t)+θ′_{A}−θ′_{B})}. The optical power in the lower output of Coupler 108 corresponding to the optical signal amplitude D₂is P₂=Pₒₚₜ{(A²+1)/2+A sin (θ_{RF}t−θ(t)+θ′_{A}−θ′_{B})}.

Detectors 110 transform the optical signal into a signal current output that corresponds to the difference in photocurrents in the upper detector and lower detector. The signal current output is characterized by the function i_{RF}(t)=i_{d}=A_{R}PₒₚₜA sin (ω_{RF}t−θ(t)+(θ_{A}−θ_{B})). The factor A_{R} defines the photodetector responsivity in Amps/Watt and the factor (θ_{A}−θ_{B}) is a constant defining the optical path phase difference through the two branches of the lightwave circuit 100. Detectors 110 produce the information data stream as a pure phase modulation on the RF or IF current. The phase information is contained in the CPM formatted term θ(t).

Filter 112 may be coupled to detectors 110. Filter 112 can be used to remove DC current superposed on the RF or IF current received from detectors 110. Filter 112 may be a high pass filter. Filter 112 may be employed in circumstances where coupler 108 departs from an ideal 2×2 coupler or detectors 110 are not exactly balanced. In these circumstances, DC current may be superposed on the RF or IF current.

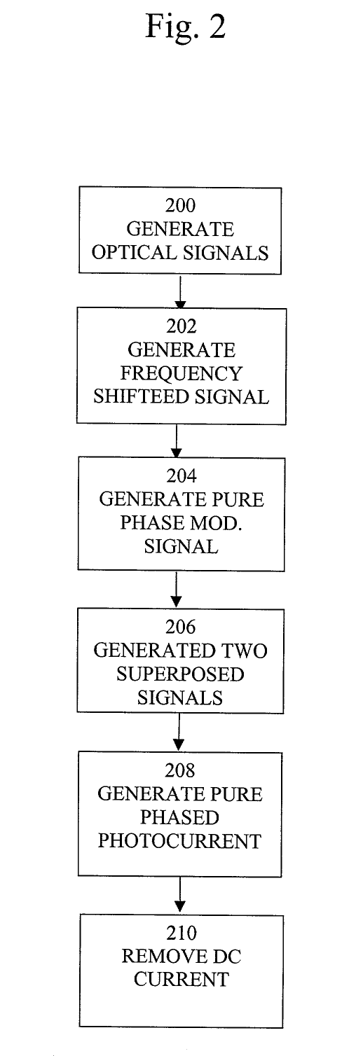

FIG. 2 is an exemplary flow diagram of a method for performing photonic constant envelope RF modulation according to an embodiment of the present invention. In the embodiment of FIG. 2, in step 200, a first and a second optical signal are generated. Each optical signal may represent nominally one half of an original optical signal. In step 202, a frequency shifted optical signal is generated. The frequency shifted optical signal can be generated by diffracting a first optical signal with an acoustic wave generated by an IF or RF carrier signal. An acoustic-optic frequency shifter provides a shifted optical signal. In step 204, a pure phase modulated optical signal is generated. The pure phase modulated optical signal can be generated by impressing an information data stream to one of the generated first or second generated optical signals through the linear electro-optic effect. In step 206, two superposed optical signals are generated. The two superposed optical signals are generated by superposing the pure phase modulate signal and the frequency shifted optical signal are superposed. In step 208, a pure phased modulated photocurrent is generated. The pure phase modulated photocurrent is generated by transforming the two optical signals to produce a sinusoidal signal at the carrier frequency with pure phase modulation. If DC current is present in the pure phase modulated photocurrent, in step 210, a high pass filter removes the DC current.

While specific embodiments of the present invention have been illustrated and described, it will be understood by those having ordinary skill in the art that changes may be made to those embodiments without departing from the spirit and scope of the invention.

What is claimed is:

1. A method for performing photonic constant envelope modulation (CPM), the method comprising:
generating, from an input coherent optical signal, a frequency shifted optical signal;
A generating, from the input coherent optical signal, a pure phase modulated optical signal, the phase modulation corresponding to an information data stream; and
generating a pure phase modulated photocurrent signal, the phase modulation corresponding to the information data stream;
wherein introducing the CPM onto the optical signal increases the upper limit on data rates and throughput capacity.

2. The method according to claim 1, further comprising:
generating a first optical signal and a second optical, wherein the first optical signal and the second optical signal each represent nominally one half of an input optical signal.

3. The method according to claim 2, wherein the step of generating the frequency shifted optical signal consists of diffracting the first optical signal with an acoustic wave of a carrier signal.

4. The method according to claim 4, wherein the carrier signal is one of: IF and RF frequency.

5. The method according to claim 2, wherein the step of generating the pure phase modulated optical signal includes passing the second optical signal through an electro-optically active medium subject to an electric field containing an information data stream.

6. The method according to claim 2, further comprising generating two superposed optical signals.

7. The method according to claim 6, wherein generating the two superposed optical signals include superposing the pure phased modulated signal and the frequency shifted optical signal.

8. The method according to claim 6, wherein two superposed optical signals are phase shifted from one another by π/2.

9. The method according to claim 7, wherein the step of generating the pure phased modulated photocurrent signal includes generating separate photcurrents for each of the two superposed optical signals.

10. The method according to claim 9, further comprising:
removing a DC current from the pure phase modulated photocurrent signal.

11. A system for performing photonic constant envelope modulation, the system comprising:
a first modulator operable to generate a frequency shifted optical signal; a second modulator operable to generate a pure phase modulated optical signal; and
a set of detectors operable to generate a pure phase modulated photocurrent signal corresponding to an information data stream;
wherein the photonic implementation of CPM allows modulation in high data rate applications by increasing the upper limit on data rates and throughput capacity by performing the modulation functions on optical frequency signals..

12. The system according to claim 11, further comprising:
a splitter, coupled to an input of the first modulator and an input of the second modulator, operable to generate a first optical signal and a second optical, wherein the first optical signal and the second optical signal each represent nominally one half of an input optical signal.

13. The system according to claim 12, wherein the first modulator diffracts the first optical signal with an acoustic wave of a carrier frequency signal.

14. The system according to claim 13, wherein the first modulator selects a propagation direction with respect to the propagation direction of the carrier frequency acoustic wave for the first optical signal.

15. The system according to claim 14, wherein the carrier signal is one of: IF or RF.

16. The system according to claim 12, wherein second modulator provides an electric field provided with an information data stream for phase modulating the second optical signal.

17. The system according to claim 11, further comprising a coupler, coupled to an output of the first modulator and an output of the second modulator, operable to generate two superposed optical signals.

18. The system according to claim 17, wherein each of the two superposed optical signals include the pure phase modulated signal and the frequency shifted optical signal.

19. The system according to claim 18, wherein the two superposed optical signals are phased from one another by π/2.

20. The system according to claim 19, the set of detectors operable to generate a photocurrent for each of the two superposed optical signals.

21. The system according to claim 11, further comprising:
a filter, coupled to the set of detectors, operable to remove a residual DC current from the pure phase modulated photocurrent signal.
